(19) United States
(12) Patent Application Publication
(10) Pub. No.: US 2025/0349621 A1
(43) Pub. Date: Nov. 13, 2025

(54) SEMICONDUCTOR PROCESS MODELING METHOD AND SYSTEM

(71) Applicant: SAMSUNG ELECTRONICS CO., LTD., Suwon-si (KR)

(72) Inventors: Shigenobu Maeda, Suwon-si (KR); Kyung Tae Kim, Suwon-si (KR); Min Hong Yun, Suwon-si (KR); Ji Ho Kim, Suwon-si (KR); Sang Yoon Park, Suwon-si (KR)

(21) Appl. No.: 19/015,489

(22) Filed: Jan. 9, 2025

(30) Foreign Application Priority Data
May 10, 2024 (KR) 10-2024-0061975

(51) Int. Cl. H01L 21/66; H01L 21/67

(52) U.S. Cl. CPC H01L 22/12; H01L 21/67253

(57) ABSTRACT

A semiconductor process modeling method is performed by a computing device, and includes obtaining a plurality of first raw data including values of a process parameter on a plurality of first wafers and a plurality of second raw data including values of a process recipe on the plurality of first wafers; preprocessing the plurality of first raw data and the plurality of second raw data to generate a plurality of first tensor data corresponding to the plurality of first raw data and a plurality of second tensor data corresponding to the plurality of second raw data; and inputting the plurality of first tensor data and the plurality of second tensor data into a predictive model, and thus, outputting, from the predictive model, a plurality of output data including values of a process parameter on a second wafer.

### CROSS-REFERENCE TO RELATED APPLICATIONS

Pursuant to 35 U.S.C. 119, this application claims priority to Korean Patent Application No. 10-2024-0061975, filed in the Korean Intellectual Property Office on May 10, 2024, the contents of which are incorporated by reference in their entirety.

### BACKGROUND

To optimize a semiconductor process, a system is used to predict a process yield, a measurement value, and a semiconductor process equipment state based on fault detection and classification (FDC) data that indicate various process parameters and a state of semiconductor process equipment while a process is performed. This system is mainly used to analyze causes of a process fault. Recently, a model has been implemented that predicts FDC data on a wafer to be processed later based on FDC data of wafers that have already been processed. However, although this model predicts change over time in the FDC data well, the model is poor at predicting the FDC data at a point at which a state of the semiconductor process equipment changes due to regular inspection and maintenance.

### SUMMARY

In general, in some aspects, the present disclosure is directed toward a method of modeling a process parameter of a wafer to be processed later based on both a process parameter and a process recipe of a wafer that has already been processed and a method of modeling a process parameter based on change in a process recipe using a Q-learning model which uses a process parameter as a state and uses a process recipe as an action, in which a semiconductor process modeling method improves prediction consistency at which a process parameter is predicted at a point at which a state of a semiconductor process equipment changes due to regular inspection and maintenance.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using means illustrated in the claims and combinations thereof.

According to some implementations, the present disclosure is directed to a semiconductor process modeling method that may be performed by a computing device, and may include obtaining a plurality of first raw data including values of a process parameter on a plurality of first wafers and a plurality of second raw data including values of a process recipe on the plurality of first wafers; preprocessing the plurality of first raw data and the plurality of second raw data to generate a plurality of first tensor data corresponding to the plurality of first raw data and a plurality of second tensor data corresponding to the plurality of second raw data; and inputting the plurality of first tensor data and the plurality of second tensor data into a predictive model, and thus, outputting, from the predictive model, a plurality of output data including values of a process parameter on a second wafer.

According to some implementations, the present disclosure is directed to a semiconductor process modeling system that includes semiconductor process equipment configured to perform a semiconductor process according to a set process recipe to manufacture a resulting product; a preprocessing module configured to: obtain, from the semiconductor process equipment, a plurality of first raw data including values of a process parameter on a plurality of first wafers and a plurality of second raw data including values of the process recipe on the plurality of first wafers; and preprocess the plurality of first raw data and the plurality of second raw data to generate a plurality of first tensor data corresponding to the plurality of first raw data and a plurality of second tensor data corresponding to the plurality of second raw data; and a modeling module configured to input the plurality of first tensor data and the plurality of second tensor data into a predictive model and to output, from the predictive model, a plurality of output data including values of a process parameter on a second wafer.

According to some implementations, the present disclosure is directed to a computer device that includes a processor; and a memory connected to the memory and configured to store therein instructions, wherein when the instructions are executed by the processor, the instructions may cause the processor to perform: obtaining a plurality of first raw data including values of a process parameter on a plurality of first wafers and a plurality of second raw data including values of a process recipe on the plurality of first wafers; preprocessing the plurality of first raw data and the plurality of second raw data to generate a plurality of first tensor data corresponding to the plurality of first raw data and a plurality of second tensor data corresponding to the plurality of second raw data; and inputting the plurality of first tensor data and the plurality of second tensor data into a predictive model, and thus, outputting, from the predictive model, a plurality of output data including values of a process parameter on a second wafer.

### BRIEF DESCRIPTION OF DRAWINGS

Example implementations will be more clearly understood from the following detailed description, in conjunction with the accompanying drawings.

FIG. 1 is a block diagram showing an example configuration of a semiconductor process modeling system according to some implementations.

FIG. 2 shows an example of raw data according to some implementations.

FIG. 3 shows an example of tensor data according to some implementations.

FIG. 4 shows example operations of a preprocessing module and a modeling module in FIG. 1 according to some implementations

FIG. 5 shows an example in which a predictive model in FIG. 4 is embodied as a Q-learning model according to some implementations

FIG. 6 shows an example configuration of the predictive model in FIG. 4 according to some implementations.

FIG. 7 is a block diagram showing an example configuration of a computer system according to some implementations.

FIG. 8 is a block diagram for illustrating an example configuration of a computer system that accesses a computer-readable medium according to some implementations.

FIG. 9 is a flowchart for illustrating an example of a semiconductor process modeling method according to some implementations.

FIG. 10 is a flowchart showing an example of a step of outputting a plurality of output data in FIG. 9 according to some implementations.

FIG. 11 is a flowchart showing an example of the step of outputting the plurality of output data in FIG. 9 according to some implementations.

FIG. 12 illustrates an example of change in a process parameter over time according to some implementations.

FIG. 13 illustrates an example of a time duration elapsed after PM corresponding to each wafer according to some implementations.

FIG. 14 illustrates an example correlation between a time duration elapsed after PM and a process parameter according to some implementations.

FIG. 15 illustrates an example relationship between predicted and actual values of a process parameter in each of a case where a process recipe is included in in semiconductor process modeling and a case where a process recipe is excluded from semiconductor process modeling according to some implementations.

### DETAILED DESCRIPTION

Hereinafter, example implementations will be described in detail with reference to the accompanying drawings. Advantages and features of the present disclosure, and a method of achieving the advantages and features will become apparent with reference to embodiments described later in detail together with the accompanying drawings. However, embodiments of the present disclosure are not limited to the embodiments as disclosed below, but may be implemented in various different forms. Thus, these embodiments are set forth only to make the present disclosure complete, and to completely inform the scope of the present disclosure to those of ordinary skill in the technical field to which the present disclosure belongs, and the present disclosure is only defined by the scope of the claims.

The same reference numbers in different drawings represent the same or similar elements, and as such perform similar functionality. Further, descriptions and details of well-known steps and elements are omitted for simplicity of the description. Furthermore, in the present disclosure, specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure gist of the present disclosure. Examples of various implementations are illustrated and described further below. It will be understood that the description herein is not intended to limit the claims to the specific implementations described. On the contrary, it is intended to cover alternatives, modifications, and equivalents as may be included within the spirit and scope of the present disclosure as defined by the appended claims.

Unless otherwise defined, all terms including technical and scientific terms used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. The terminology used herein is directed to the purpose of describing particular implementations only and is not intended to be limiting of the present disclosure. As used herein, the singular constitutes “a” and “an” are intended to include the plural constitutes as well, unless the context clearly indicates otherwise.

Additionally, in describing the components of the present disclosure, terms such as first, second, A, B, a, and b may be used. These terms are only used to distinguish one component from another component, and the nature, sequence, order, or number of the component are not limited by the term. It should be understood that when a component is described as being “connected,” “coupled,” or “combined” to another component, the component may be directly connected, coupled, or combined to another component, still another component may be “interposed” therebetween, and thus the component may be connected, coupled, or combined to another component via the sill another component.

It will be further understood that the terms “comprise”, “comprising”, “include”, and “including” as used herein specify the presence of the stated features, steps, operations, elements, and/or components, but do not preclude the presence or addition of one or more other features, steps, operations, elements, components, and/or portions thereof.

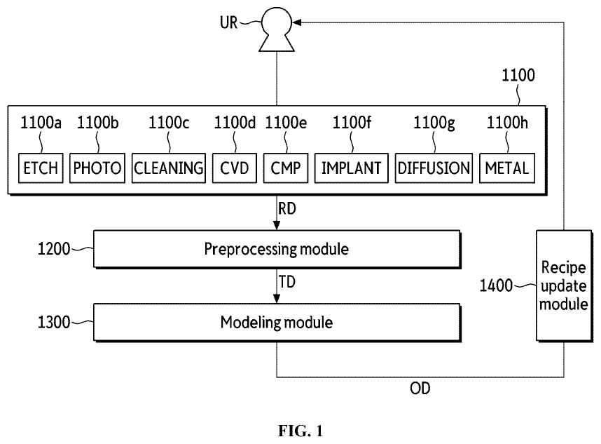

FIG. 1 is a block diagram showing an example configuration of a semiconductor process modeling system according to some implementations. In FIG. 1, a semiconductor process modeling system 1000 may include a semiconductor process equipment 1100, a preprocessing module 1200, a modeling module 1300, and a recipe update module 1400. In this regard, the components (modules) of the semiconductor process modeling system 1000 as shown in FIG. 1 refer to functionally distinct functional elements. It should be appreciated that at least two components (modules) may be integrated with each other in an actual physical environment.

In FIG. 1, the semiconductor process equipment 1100 is shown as including first to eighth equipment 1100a to 1100h. However, the number of equipment is not limited thereto, and the number of semiconductor manufacturing equipment may be any natural number. The semiconductor process equipment 1100 may include various semiconductor manufacturing equipment used in a semiconductor process.

In some implementations, the first equipment 1100a may include am etching apparatus. The first equipment 1100a may be configured to remove at least a portion of the wafer or a material layer on the wafer. The first equipment 1100a may include at least one of a dry etching apparatus and a wet etching apparatus.

In some implementations, the second equipment 1100b may include a photolithography apparatus. The second equipment 1100b may be configured to form a photoresist pattern on the wafer. For example, the second equipment 1100b may be configured to form a photoresist layer on the wafer, expose a portion of the photoresist layer to light, and remove a portion of the photoresist layer. The second equipment 1100b may include at least one of a photoresist application apparatus (e.g., a spin coating apparatus), a light exposure apparatus, and a development apparatus.

In some implementations, the third equipment 1100c may include a cleaning apparatus. The third equipment 1100c may be configured to remove residue or contaminants on the wafer or the material layer on the wafer. The third equipment 1100c may include at least one of a wet cleaning apparatus, a dry cleaning apparatus, and a water vapor cleaning apparatus.

In some implementations, the fourth equipment 1100d may include a chemical vapor deposition (CVD) apparatus. The fourth equipment 1100d may be configured to form the material layer on the wafer using a chemical vapor deposition method. The fourth equipment 1100d may include at least one of a thermal CVD apparatus, a plasma CVD apparatus, and an optical CVD apparatus. In one example, the fourth equipment 1100d may further include at least one of a physical vapor deposition (PVD) apparatus, an atomic layer deposition (ALD) apparatus, and an electrical plating apparatus.

In some implementations, the fifth equipment 1100e may include a chemical physical polishing (CMP) apparatus. The fifth equipment 1100e may planarize or remove the wafer or the material layer on the wafer by polishing the wafer or the material layer on the wafer.

In some implementations, the sixth equipment 1100f may include an implant apparatus. The sixth equipment 1100f may inject impurities into the wafer or the material layer on the wafer. The impurity may be an ion. However, embodiments of the present disclosure are not limited thereto. The impurities may include at least one of a group 15 element and a group 13 element. The group 15 element may include phosphorus (P), arsenic (As), or combinations thereof. The group 13 element may include boron (B).

In some implementations, the seventh equipment 1100g may include a diffusion apparatus. The seventh equipment 1100g may diffuse impurity ions into the wafer or the material layer on the wafer.

In some implementations, the eighth equipment 1100h may include a metalization apparatus. The eighth equipment 1100h may form a metal wiring on the wafer.

Each of the first to eighth equipment 1100a to 1100h may sequentially process the wafer according to a predetermined process recipe. For example, the process recipe may include setting values such as temperature, pressure, humidity, and process time of each of the first to eighth equipment 1100a to 1100h, a preventive maintenance (PM) period, and history of part exchange and cleaning work for equipment maintenance and repair, etc. Each of the first to eighth equipment 1100a to 1100h may include a sensor that measures at least one process parameter. For example, the process parameter may include at least one of temperature, pressure, flow rate, humidity, pH, power, voltage, and current. Furthermore, in some implementations, the process parameter may further include process result values. For example, the process results may include a yield, pattern width, pattern length, pattern diameter, hole diameter or hole depth, standard deviation of a pattern dimension, etc.

For reference, the process parameter and the process recipes may include duplicate factors (e.g., temperature, pressure, humidity, etc.). The values of the process recipe may be condition values preset for each of equipment 1100a to 1100h prior to the process, and the values of the process parameters may be values actually measured by the sensor of each of equipment 1100a to 1100h during the process.

The semiconductor process modeling system 1000 may generate tensor data DT from raw data RD including values of a process parameter and a process recipe on a plurality of wafers that have already been processed through the semiconductor process equipment 1100, and may model a semiconductor process on a wafer to be processed later based on the tensor data TD. In this regard, the modeling of the semiconductor process may include predicting the process parameter (including process result values) on the wafer to be processed later, and optimizing the process recipe based on a prediction result of the process parameter. The semiconductor process modeling system 1000 may include the preprocessing module 1200, the modeling module 1300, and the recipe update module 1400 that are executed by a computer system.

The above-mentioned raw data RD on the plurality of wafers on which the process has been performed may be stored in each of the first to eighth equipment 1100a to 1100h, or in storage external to the semiconductor process modeling system 1000. For clarity of description as set forth below, it is assumed that the raw data RD is obtained from the semiconductor process equipment 1100. However, the present disclosure is not limited thereto, and the raw data RD may be obtained from the external storage.

The preprocessing module 1200 may be configured to generate the tensor data TD from the raw data RD obtained from the semiconductor process equipment 1100. As described above, the raw data RD may correspond to the process recipe of each of the first to eighth equipment 1100a to 1100h, or may correspond to a process parameter of a process that has already been performed according to a set process recipe.

For clear description, in description of the modeling module 1300, as set forth below, raw data RD corresponding to the process parameter may be referred to as first raw data, raw data RD corresponding to the process recipe may be referred to as second raw data, and tensor data TD respectively generated based on the first raw data and the second raw data are may be referred to as first tensor data and the second tensor data, respectively.

The modeling module 1300 may model the semiconductor process to predict the process parameter of the wafer to be processed later based on the tensor data TD, and output the modeling result as output data OD. In this regard, the process parameter as a prediction target may be a measured value such as temperature, pressure, flow rate, humidity, pH, power, voltage, and current, or a process result value such as yield, pattern width, pattern length, pattern diameter, hole diameter, or hole depth, standard deviation of a dimension of a pattern, etc. The modeling module 1300 may include a predictive model as a machine learning model for performing the modeling of the semiconductor process. The modeling module 1300 may train the predictive model to predict the process parameter based on the tensor data TD.

In particular, the predictive model may include a Q-learning model as one of reinforcement learning algorithms. In the reinforcement learning algorithm, when a current state sₜ∈S is given, an agent performs an action aₜ∈A, and as a result of the action, the agent can obtain a reward rₜ and a next state sₜ+1∈S. Among the reinforcement learning algorithms, the Q-learning uses Q-values of state-action pairs as an indicator for action decision. The Q-value is also referred to as an action-value function, and may be calculated based on Equation 1 as set forth below.

$${Q}^{π} ( s , a ) = [ {\sum }_{t = 0}^{∞} {λ}^{t} {r}_{t} \vert {s}_{0} = s , {a}_{0} = a ] \qquad Equation 1$$

λ denotes a discount factor (0<λ<1) and represents a weight of a future reward relative to a current reward. In other words, the Q-value may correspond to an expected value of a sum of future rewards when an action a is taken according to a strategy π at a certain time t. Before the Q-learning algorithm starts, the Q-value may be initialized to a fixed random value. At each time t, the agent may select an action aₜ, receive a reward rₜ, and transition to a new state sₜ₊₁, and the Q-value may be updated.

In some implementations, the predictive model may include a Q-learning model in which the first tensor data corresponding to the process parameter corresponds to a state sₜ, and the second tensor data corresponding to the process recipe corresponds to the action aₜ. In other words, the modeling module 1300 may input the first tensor data corresponding to the process parameter as the state sₜ to the Q-learning model, and may input the second tensor data corresponding to the process recipe as the action aₜ to the Q-learning model.

In this regard, the time t may correspond to each of the plurality of wafers on which the process has already performed. For example, when a time corresponding to a first wafer among the plurality of wafers is t, a time corresponding to a second wafer among the plurality of wafers may be t+1, and a time corresponding to an N-th wafer among the plurality of wafers may be t+N−1. In other words, the first tensor data and the second tensor data on each of the plurality of wafers that have already been processed may be input into the Q-learning model where the expected value of a sum of compensations may be calculated. Based on the expected value, the modeling module 1300 may output the output data OD.

In one example, before inputting the first tensor data and the second tensor data into the predictive model, the modeling module 1300 may analyze a correlation between the first tensor data corresponding to the process parameter and the second tensor data corresponding to the process recipe. Specifically, the modeling module 1300 may calculate a correlation coefficient between first tensor data and the second tensor data and determine whether the calculated correlation coefficient exceeds a preset threshold.

When the correlation coefficient between the first tensor data and the second tensor data exceeds the preset threshold, the modeling module 1300 may select the first tensor data and the second tensor data as the tensor data to be input to the predictive model. Accordingly, the first tensor data and the second tensor data that have a significant correlation with each other may be selected, and the predictive model may more accurately predict the process parameter based on change in the process recipe.

The modeling module 1300 may further include a machine learning model for analyzing the correlation between the tensor data TD. The machine learning model for analyzing the correlation between the tensor data TD may include at least one of a random forest, a linear regression analysis model, and a support vector machine. However, the present disclosure is not limited thereto. In this regard, the correlation between the tensor data TD may include a correlation between the first tensor data (i.e. a correlation between process parameters) in addition to the correlation between the first tensor data and the second tensor data (i.e. the correlation between the process parameter and the process recipe).

In some implementations, the second tensor data corresponding to the process recipe may indicate a time duration elapsed since the PM execution time point. For example, the process parameter measured as a result of the process of each of equipment 1100a to 1100h may vary depending on an equipment state. Specifically, as the equipment state improves, a process parameter corresponding to a good product may be measured, whereas as the equipment state deteriorates, a process parameter corresponding to a defective product may be measured.

Since maintenance and repair of the equipment is carried out at each PM execution time point, the equipment state immediately after the PM is best, and then, the equipment state will gradually deteriorate over time. Accordingly, the process parameter measured as a larger value as the state is closer to the good product may have a maximum value immediately after the PM. Then, the value thereof may be gradually decreased as the time duration elapses after the PM. In other words, there will be a significant correlation (a negative correlation in the case as described above) between the time duration elapsed since the PM execution time point (corresponding to the process recipe) and some process parameters.

When the first tensor data corresponds to the process parameter and the second tensor data corresponds to the time duration elapsed since the PM execution time point, the first tensor data and the second tensor data may be input into the predictive model to accurately predict a process parameter (corresponding to the state in the Q-learning model) based on the PM period (corresponding to the action in Q-learning model).

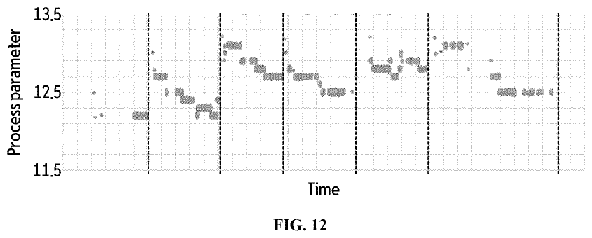

Accordingly, not only the change in the process parameter may be predicted based on the time duration elapsed since the PM execution time point, but also a value of the process parameter may be newly set to the highest value at each PM execution time point. In this regard, the value of the process parameter newly set at each PM execution time point may correspond to an initial value of the above-described predictive model (for example, an initial Q-value in the Q-learning model). An example in which the process parameter is predicted based on the PM period (the time duration elapsed since the PM execution time point) is described in more detail later with reference to FIGS. 12 to 15.

In this way, the modeling module 1300 may use the predictive model to predict the process parameter based on change in the process recipe on the wafer to be processed later and output the output data OD as the predicted process parameter. Additionally, the modeling module 1300 may provide the output data OD to the recipe update module 1400 for optimization of the process recipe.

The recipe update module 1400 may automatically update values of a process recipe to be set on the wafer to be processed later, based on the output data OD. For example, the recipe update module 1400 may separately include a machine learning model that may receive values of the process parameters indicated by the output data OD and may predict and output a yield of the wafers to be processed later. When the wafer yield predicted through the machine learning model of the recipe update module 1400 exceeds a preset threshold, the values of the process recipe may not be separately updated. However, when the predicted wafer yield is lower than or equal to the preset threshold, the values of the process recipe may be updated so as to increase the yield. For example, the updating of the process recipe values may include updating at least one of setting values such as temperature, pressure, humidity, and process time of each of the first to eighth equipment 1100a to 1100h, and the PM period. The update result may be provided to a user UR.

The user UR may control, change, or adjust the process recipe of at least one of the first to eighth equipment 1100a to 1100h based on the modeling result of the modeling module 1300 and the update result of the recipe update module 1400. For example, the user UR may control, change, or adjust at least one of the first to eighth equipment 1100a to 1100h to achieve a desired process result value on the process to be performed later. For example, in order to improve the yield, the user UR may find out the process recipe that has the greatest impact on the yield and then may control, change, or adjust at least one of the first to eighth equipment 1100a to 1100h to change the found process recipe.

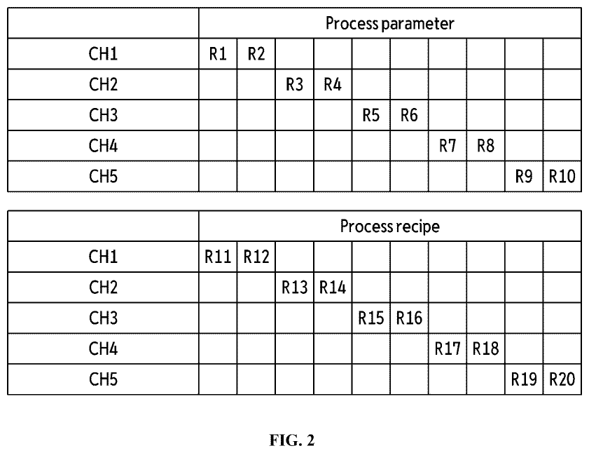

FIG. 2 shows an example of raw data RD according to some implementations. In FIG. 2, first to fifth chambers CH1 to CH5 are provided. Each of the first to fifth chambers CH1 to CH5 may be one of the semiconductor process equipment 1100 in FIG. 1. The first to fifth chambers CH1 to CH5 may be identical equipment or may be different equipment. A sensor in each of the first to fifth chambers CH1 to CH5 may measure a process parameter, and each of the first to fifth chambers CH1 to CH5 may perform a process according to a preset process recipe. The process parameter measured in each of the first to fifth chambers CH1 to CH5 may be converted into first to tenth raw data R1 to R10 which in turn may be provided to the preprocessing module 1200. The process recipe corresponding to each of the first to fifth chambers CH1 to CH5 may be converted into 11th to 20th raw data R11 to R20 which in turn may be provided to the preprocessing module 1200.

In FIG. 1, the process parameter may include at least one of pressure, flow rate, temperature, pH, humidity, and time, and the process recipe may include at least one of setting values such as temperature, pressure, humidity, and process time, and the PM period of each of the first to fifth chambers CH1 to CH5. That is, the first to tenth raw data R1 to R10 may be a raw matrix representing values of pressure, flow rate, temperature, pH, humidity, and time, and the 11th to 20th raw data R11 to R20 may be a raw matrix representing values of temperature, pressure, humidity, process time, and the PM period. Furthermore, the raw data corresponding to a resulting semiconductor device manufactured using the semiconductor process equipment may be provided to the preprocessing module 1200.

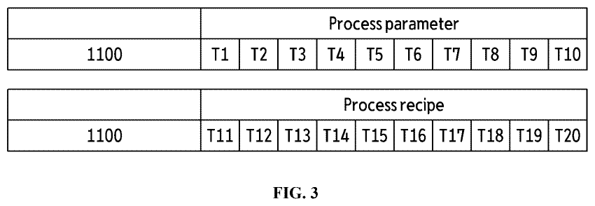

FIG. 3 shows an example of tensor data according to some implementations. In FIG. 3, the first to tenth raw data R1 to R10 corresponding to the process parameter measured from each of the plurality of chambers may be respectively replaced with first to tenth tensor data T1 to T10 of one semiconductor process equipment 1100. The 11th to 20th raw data R11 to R20 corresponding to the process recipe of each of the plurality of chambers may be respectively replaced with 11th to 20th tensor data T11 to T20 of one semiconductor process equipment 1100.

For example, the preprocessing module 1200 may generate the first to tenth tensor data T1 to T10 using the first to tenth raw data R1 to R10, and may generate the 11th to 20th tensor data T11 to T20 using the 11th to 20th raw data R11 to R20.

Subsequently, the first to tenth tensor data T1 to T10 and the 11th to 20th tensor data T11 to T20 may be categorized into one semiconductor process equipment 1100. Accordingly, all raw data may be converted into the tensor data which may in turn may be provided to the modeling module 1300. In FIG. 1, the raw data on the plurality of wafers that have already been processed may be provided from the semiconductor process equipment 1100, or may also be provided from the external storage.

Through this process, the preprocessing module 1200 may convert all process parameters and all process recipes on the plurality of wafers that have already been processed into the tensor data. Accordingly, reliability of the predictive model using the tensor data may be improved.

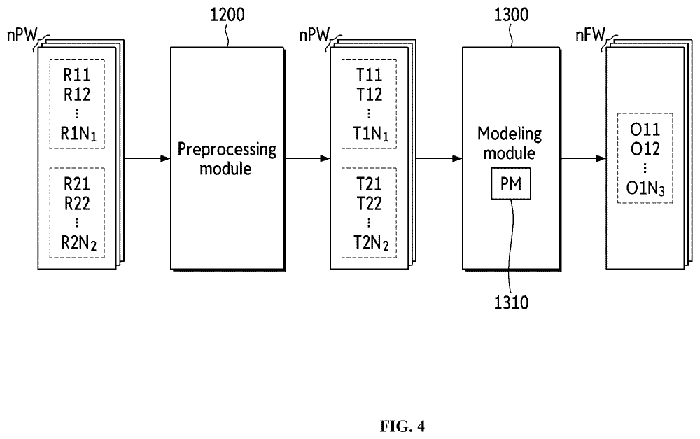

FIG. 4 shows example operations of the preprocessing module 1200 and the modeling module 1300 in FIG. 1. In FIG. 4, a plurality of first raw data R11 to R1N₁ corresponding to the process parameter and a plurality of second raw data R21 to R2N₂ corresponding to the process recipe on the plurality of wafers that have already been processed are shown. The plurality of first raw data R11 to R1N₁ and the plurality of second raw data R21 to R2N₂ may be respectively replaced with a plurality of first tensor data T11 to T1N₁ and a plurality of second raw data T21 to T2N₂ through the preprocessing module 1200.

Afterwards, the plurality of first tensor data T11 to T1N₁ and the plurality of second tensor data T21 to T2N₂ may be input into the predictive model PM of the modeling module 1300 which in turn may output a plurality of output data O11 to O1N₃ on a wafer to be processed later.

In this regard, the number of the plurality of wafers on which the process has already performed is nPW, the number of the first raw data (i.e., the number of the process parameters) is N₁, and the number of the second raw data (i.e., the number of the process recipes) is N₂. The number of the output data (i.e., the number of the predicted process parameters) is N₃, and the number of the wafers to be subjected to a subsequent process as a prediction target is nFW. All of nPW, N₁, N₂, N₃, and nFW are random natural numbers.

The greater the number of the plurality of wafers nPW that has been already processed, the higher the prediction accuracy of the predictive model PM, while the larger a time required to operate the predictive model PM. Furthermore, in some implementations, an example in which the number of the wafers nFW to be processed later is 1 is described. However, the present disclosure is not limited thereto, and the plurality of output data O11 to O1N₃ on a larger number of wafers may be output.

In some implementations, as described with reference to FIG. 1, the modeling module 1300 may calculate each correlation coefficient between each of the plurality of first tensor data T11 to T1N₁ and each of the plurality of second tensor data T21 to T2N₂, and may select the first tensor data and second tensor data between which the calculated correlation coefficient exceeds the preset threshold, and may input the selected first tensor data and the selected second tensor data into the predictive model PM.

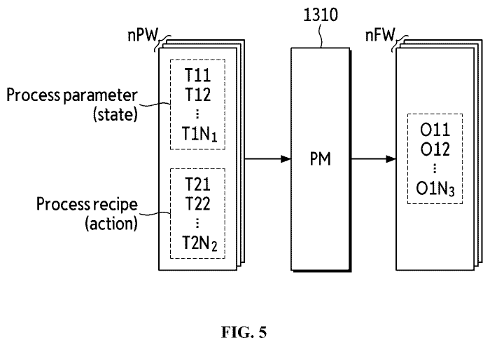

FIG. 5 shows an example in which a predictive model PM in FIG. 4 is embodied as the Q-learning model according to some implementations. In FIG. 5, the plurality of first tensor data T11 to T1N₁ corresponding to the process parameter may be input as the state sₜ of the Q-learning model, and the plurality of second tensor data T21 to T21 to T2N₂ may be input as the action aₜ of the Q-learning model. The predictive model PM may be trained so as to maximize the Q-value based on the input state sₜ and action aₜ.

The action-value function may be implemented using the values of the process parameter and the process recipe on the plurality of wafers that have already been processed, such that a prediction consistency at which the process parameter is predicted based on the state change of the semiconductor process equipment (for example, based on the PM period) may be increased.

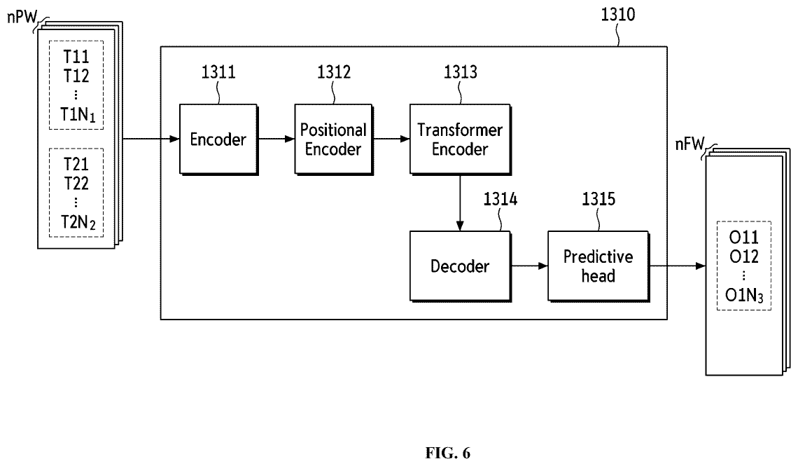

FIG. 6 shows an example configuration of the predictive model PM in FIG. 4 according to some implementations. In FIG. 6, the predictive model PM may include an encoder 1311, a positional encoder 1312, a transformer encoder 1313, a decoder 1314, and a predictive head 1315.

The encoder 1311 may encode the plurality of tensor data T11 to T1N₁ or T21 to T2N₂ representing the process parameter or the process recipe to generate an embedding vector. The positional encoder 1312 may add position information to the generated embedding vector. In this regard, when the embedding vector represents the process parameter or the process recipe of a specific wafer among the plurality of wafers on which the process has already been performed, the position information may indicate an order of the specific wafer.

Under the operation of the encoder 1311 and the positional encoder 1312 as described above, the tensor data corresponding to each of the plurality of wafers may be encoded into the embedding vector, and the position information indicating the order of the specific wafer among the plurality of wafers corresponding to the embedding vector may be added to the generated embedding vector. That is, the output of the positional encoder 1312 may be the embedding vector to which wafer order information has been applied.

The transformer encoder 1313 may receive the embedding vector to which the position information has been added from the positional encoder 1312, and may predict the process parameter values using an internal neural network (e.g., feed-forward neural network (FFN)), and may output the embedding vector corresponding to the predicted process parameter values via the decoder 1314.

The transformer encoder 1313 may have preset input/output dimensions, the number of layers, the number of heads, and a size of the neural network as parameters. For example, the decoder 1314 may use a rectified linear unit (ReLU) function. However, embodiments of the present disclosure are not limited thereto. The embedding vector output from the decoder 1314 may correspond to a process parameter value on a wafer to be processed later.

Finally, the predictive head 1315 may receive the embedding vector output from the decoder 1314 and generate the plurality of output data O11 to O1N₃ including the process parameter values on the wafer to be processed later, based on the embedding vector. For example, the predictive head 1315 may predict a class and a bounding box on the embedding vector output from the decoder 1314 to generate the output data.

The configuration as shown in FIG. 6 and the operation as described above are merely examples, and the present disclosure is not limited thereto. In some implementations, all of the components of the predictive model PM as shown in FIG. 6 may be integrated into a single transformer. Furthermore, the operations in FIGS. 4 to 6 may be performed on all steps performed by each of the first to eighth equipment 1100a to 1100h. In other words, the semiconductor process modeling method is not limited to specific equipment, and is applicable to all equipment.

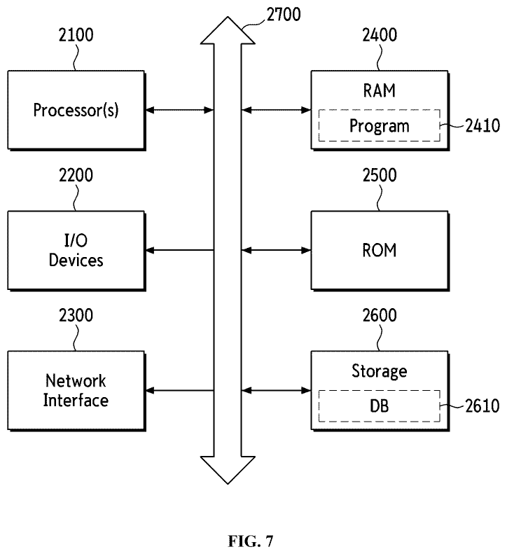

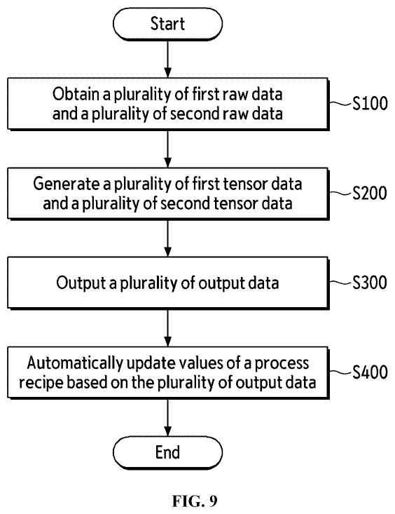

FIG. 7 is a block diagram showing an example configuration of a computer system 2000 according to some implementations. A semiconductor process modeling method which will be described with reference to FIGS. 9 to 11 may be performed in the computer system 2000.

In FIG. 7, the computer system 2000 may include at least one computing device. For example, the computer system 2000 may include a first computing device on which the preprocessing module 1200 of FIG. 1 is executed, a second computing device on which the modeling module 1300 of FIG. 1 is executed, and a third computing device on which the recipe update module 1400 of FIG. 1 is executed. In some implementations, the preprocessing module 1200, the modeling module 1300, and the recipe update module 1400 may be executed on a single computing device. The computing device may be a stationary computing device, such as a desktop computer, a workstation, a server, etc., or a portable computing device, such as a laptop computer, a tablet, a smartphone, etc.

In some implementations, the computer system 2000 may include a processor 2100, input/output devices 2200, a network interface 2300, a random access memory (RAM) 2400, a read only memory (ROM) 2500, and a storage device 2600. The processor 2100, the input/output devices 2200, the network interface 2300, the RAM 2400, the ROM 2500, and the storage device 2600 may be connected to a bus 2700 and may communicate with each other via the bus 2700.

The processor 2100 may be referred to as a processing unit. The processor 2100 may include at least one core capable of executing an arbitrary instruction set (e.g., Intel Architecture-32 (IA-32), 64-bit extension IA-32, x86-64, PowerPC, Sparc, MIPS, ARM, IA-64, etc.), such as a micro-processor, an application processor (AP), a digital signal processor (DSP), and a graphic processing unit (GPU). For example, the processor 2100 may access a memory, that is, the RAM 2400 or the ROM 2500 via the bus 2700 and may execute instructions stored in the RAM 2400 or the ROM 2500.

The RAM 2400 may store therein a program 2410 for semiconductor process modeling or a portion thereof. The program 2410 for the semiconductor process modeling may enable the processor 2100 to perform the semiconductor process modeling method. That is, the program 2410 for the semiconductor process modeling may include a plurality of instructions executable by the processor 2100 when being loaded into the RAM 2400. The plurality of instructions included in the program 2410 for the semiconductor process modeling may cause the processor 2410 to perform the semiconductor process modeling method.

The storage device 2600 may store data therein. Even when power supplied to the computer system 2000 is cut off, the data stored in the storage device 2600 may not be lost. For example, the storage device 2600 may include a non-volatile memory device or a storage medium such as a magnetic tape, an optical disk, or a magnetic disk.

The input/output devices 2200 may include an input device such as a keyboard and a pointing device, and may include an output device such as a display device and a printer. For example, the user may trigger execution of the program 2410 under the processor 2100 through the input/output devices 2200 and check resulting data through the input/output devices 2200.

The network interface 2300 may provide access to a network external to the computer system 2000. For example, the network may include a number of computing systems and communication links, and the communication links may include wired links, optical links, wireless links, or any other types of links.

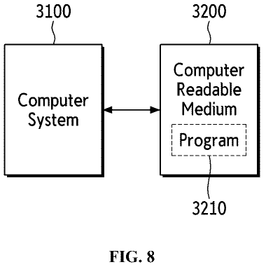

FIG. 8 is a block diagram for illustrating an example configuration of a computer system 3100 that accesses a computer-readable medium 3200 according to some implementations. In FIG. 8, the computer system 3100 may access the computer-readable medium 3200 and execute a program 3210 stored in the computer-readable medium 3200. In some implementations, the computer system 3100 and the computer-readable medium 3200 may be collectively referred to as a semiconductor process modeling system.

The computer system 3100 may include at least one computer subsystem, and the program 3210 stored in the computer-readable medium 3200 may include at least one module executed by the at least one computer subsystem. For example, the at least one module may include the preprocessing module 1200 in FIG. 1, the modeling module 1300 in FIG. 1, and the recipe update module 1400 in FIG. 1. In a similar manner to the storage device 2600 in FIG. 7, the computer-readable medium 3200 may include a non-volatile memory device or may include a storage medium such as a magnetic tape, an optical disk, and a magnetic disk. Furthermore, the computer-readable medium 3200 may be removable from the computer system 3100.

Hereinafter, with reference to FIGS. 9 to 11, the semiconductor process modeling method is described. For reference, FIGS. 9 to 11 show steps/operations performed in the semiconductor process modeling system 1000 in FIG. 1. Accordingly, in the descriptions as set forth below, when a subject of a specific step/operation is omitted, the step/operation may be performed in the semiconductor process modeling system 1000 in FIG. 1. Hereinafter, the description is made with reference to FIG. 1, along with FIGS. 9 to 11.

FIG. 9 is a flowchart for illustrating an example of a semiconductor process modeling method according to some implementations. In FIG. 9, in step S100, the plurality of first raw data including values of the process parameter on a plurality of first wafers on which the process has already been performed and the plurality of second raw data including values of the process recipe may be obtained. For example, the plurality of first raw data and the plurality of second raw data may be obtained from the semiconductor process equipment 1100 or from the external storage.

In step S200, via preprocessing of the plurality of first raw data and the plurality of second raw data, the plurality of first tensor data corresponding to the plurality of first raw data and the plurality of second tensor data corresponding to the plurality of second raw data may be generated.

Then, in step S300, the plurality of first tensor data and the plurality of second tensor data may be input to the predictive model, and the plurality of output data including values of the process parameter on a second wafer to be processed later may be outputted. For example, the predictive model may include the Q-learning model. In this case, the plurality of first tensor data may be input as the state of the Q-learning model, and the plurality of second tensor data may be input as the action of the Q-learning model.

Finally, in step S400, values of the process recipe to be performed later may be automatically updated based on the plurality of output data. In this regard, the plurality of output data may further include process result values on the second wafer. For example, whether the values of the process recipe are to be updated may be determined based on the yield of the second wafer which may be predicted based on the plurality of output data.

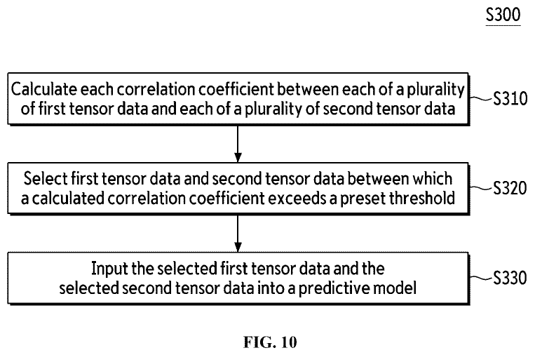

FIG. 10 is a flowchart showing one embodiment of the step S300 of outputting the plurality of output data in FIG. 9 according to some implementations. In FIG. 10, in step S310, each correlation coefficient between each of the plurality of first tensor data and each of the plurality of second tensor data may be calculated. In step S320, first tensor data and second tensor data between which the calculated correlation coefficient exceeds the preset threshold may be selected from among the plurality of first tensor data and the plurality of second tensor data. Then, in step S330, the selected first tensor data and the selected second tensor data may be input to the predictive model. As a result, the values of the process parameter and the process recipe that have a significant correlation with each other may be input into the predictive model, and the prediction consistency at which the process parameter is predicted based on the change in the process recipe may be improved.

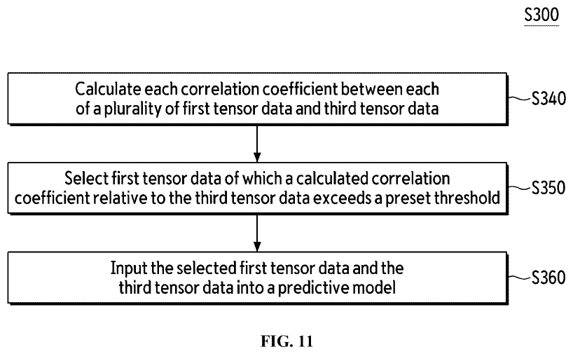

In some implementations, the plurality of second tensor data may include third tensor data indicating the time duration elapsed since the PM execution time point. This example is described with reference to FIG. 11.

FIG. 11 is a flowchart showing an example of the step S300 of outputting the plurality of output data in FIG. 9 according to some implementations. In FIG. 11, in step S340, each correlation coefficient between each of the plurality of first tensor data and the third tensor data may be calculated. In step S350, first tensor data whose the calculated correlation coefficient relative to the third tensor data exceeds a preset threshold may be selected. Then, in step S360, the selected first tensor data and the third tensor data may be input to the predictive model. As a result, a prediction consistency at which the process parameter is predicted based on the time duration elapsed since the PM execution time point (i.e., based on the state of the semiconductor process equipment) may be improved.

Hereinafter, with reference to FIGS. 12 to 15, an implementations in which the process parameter is predicted based on the PM period (the time duration elapsed since the PM execution time point) as shown in FIG. 11 is described in detail.

FIG. 12 shows an example of change in the process parameter over time according to some implementations. In FIG. 12, a dotted line indicates a PM execution time point, and a spacing between adjacent dotted lines may correspond to the PM period. The process parameter in FIG. 12 gradually decreases over time, while an initial value thereof is set to a new value at each PM execution time point. For example, the process parameter in FIG. 12 may be a process parameter that is measured as having a larger value as the product state is closers to a good product state. In this case, the process parameter in FIG. 12 may have a negative correlation with respect to the time duration elapsed since the PM execution time point.

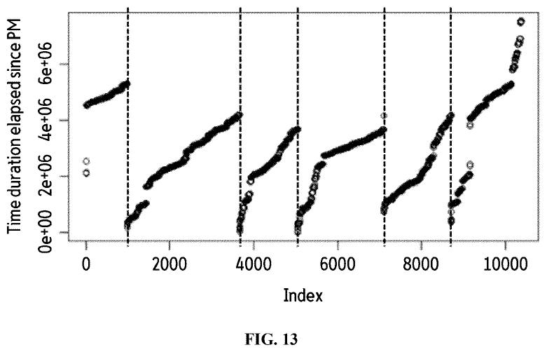

FIG. 13 shows an example of the time duration elapsed since the PM execution time point corresponding to each wafer according to some implementations. A horizontal axis of FIG. 13 represents an index of wafers that have been sequentially processed by the semiconductor process equipment 1100 in FIG. 1. For example, wafer 1 to wafer 10000 may represent 10000 wafers sequentially processed by the semiconductor process equipment 1100 in FIG. 1. A vertical axis in FIG. 13 represents the time duration elapsed since the PM execution time point. In FIG. 13, the dotted line indicates the PM execution time point. At the PM execution time point, the time duration elapsed after the PM is 0, and the time duration elapsed after the PM gradually increases until just before a next PM. In other words, the wafer with the index corresponding to the dotted line in FIG. 13 may be a wafer that has been processed immediately after the PM on the semiconductor process equipment 1100 in FIG. 1 has been completed.

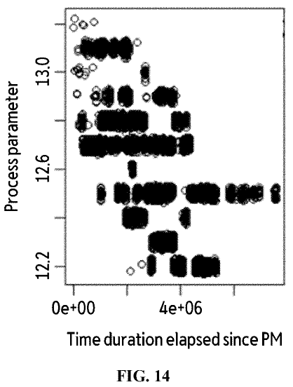

FIG. 14 shows an example correlation between the time duration elapsed since the PM execution time point and the process parameter according to some implementations. In FIG. 14, the process parameter in FIG. 14 has its maximum value immediately after the PM, and its value gradually decreases over time after the PM. That is, in FIG. 14, a negative correlation between the time duration elapsed since the PM execution time point and the process parameter may be present. For example, the process parameter in FIG. 14 may be the same process parameter as the process parameter in FIG. 12.

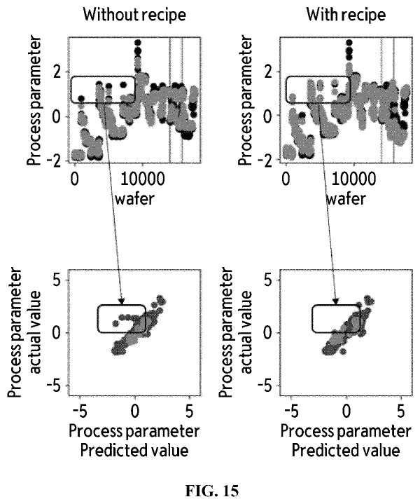

FIG. 15 illustrates an example relationship between predicted and actual values of a process parameter in each of a case where a process recipe is included in in semiconductor process modeling and a case where a process recipe is excluded from semiconductor process modeling according to some implementations. In FIG. 15, each of upper graphs shows an actual value (shown in black) and a predicted value (shown in gray) of the process parameter that changes as the process progresses sequentially on a plurality of wafers, while each of lower graphs shows a correlation between the actual and predicted values of the process parameter.

In this regard, the upper left and lower left graphs show an example in which the tensor data corresponding to the process recipe (the time duration elapsed since the PM execution time point) are not used to predict the process parameter. The upper right and lower right graphs show an example in which the tensor data corresponding to the process recipe (the time duration elapsed since the PM execution time point) are used to predict the process parameter in accordance with some implementations of the present disclosure.

Based on a comparing result of the upper left and upper right graphs, it may be identified that the prediction consistency (i.e., a matching percentage between the points shown in black and the points shown in red) is high when the process recipe is used for the prediction. Furthermore, based on a comparing result of the bottom left and bottom right graphs, it may be identified that when the process recipe is used for the prediction, an outlier (e.g., a rectangular area in the bottom left graph) as shown in the graph of the correlation coefficient between the actual and predicted values of the process parameter has been removed.

In FIGS. 12 to 15, it is identified that when the process recipe is used to predict the process parameter in accordance with some implementations of the present disclosure, the prediction consistency at which the process parameter is predicted is higher. In particular, according to some implementations of the present disclosure, the prediction consistency at which the change in the process parameter is predicted based on the time duration elapsed since the PM execution time point (i.e., the change in the process parameter is predicted based on the state change of the semiconductor process equipment) may be improved.

According to some implementations of the present disclosure, in the prediction process of the process parameter for the semiconductor process modeling, process recipe information preset on the semiconductor process equipment may be used together therewith such that change tendency of the process parameter due to external factors such as change in the process recipe may be predicted more accurately. In particular, in an existing semiconductor process modeling method, the process parameter could not be accurately predicted based on the change in the equipment state. However, according to the present disclosure, the prediction consistency at which the process parameter is predicted based on the change in the equipment state may be significantly improved.

Various implementations of the present disclosure and the effects according to those implementations have been described above with reference to FIGS. 1 to 15. The effects according to the present disclosure are not limited to the effects as mentioned above, and other effects not mentioned may be clearly understood from the above descriptions.

All the components that constitute the implementations of the present disclosure are described as being combined with each other or operating in combination with each other. However, the present disclosure is not necessarily limited to these implementations. In other words, within the scope of the purpose of the present disclosure, all of the components may operate in a selective combination manner of at least two thereof with each other.

Although the operations are shown as being executed in a specific order in the drawings, it should not be understood that the operations should be performed in the specific order as shown or in a sequential order or that all illustrated operations should be performed to obtain the desired result.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

What is claimed is:

1. A semiconductor process modeling method, the method comprising:
obtaining, by at least one processor, a plurality of first raw data including values of a process parameter on a plurality of first wafers and a plurality of second raw data including values of a process recipe on the plurality of first wafers;
preprocessing, by the at least one processor, the plurality of first raw data and the plurality of second raw data to generate a plurality of first tensor data corresponding to the plurality of first raw data and a plurality of second tensor data corresponding to the plurality of second raw data;
inputting, into a predictive model, the plurality of first tensor data and the plurality of second tensor data; and
outputting from the predictive model, a plurality of output data including values of a process parameter on a second wafer.

2. The semiconductor process modeling method of claim 1, wherein the inputting the plurality of first tensor data and the plurality of second tensor data into the predictive model includes:
calculating each correlation coefficient between each of the plurality of first tensor data and each of the plurality of second tensor data;
selecting, from among the plurality of first tensor data and the plurality of second tensor data, first tensor data and second tensor data between which a calculated correlation coefficient exceeds a preset threshold; and
inputting the selected first tensor data and the selected second tensor data into the predictive model.

3. The semiconductor process modeling method of claim 1,
wherein the predictive model includes a Q-learning model,
wherein the inputting the plurality of first tensor data and the plurality of second tensor data into the predictive model includes:
inputting the plurality of first tensor data as a state of the Q-learning model into the predictive model; and
inputting the plurality of second tensor data as an action of the Q-learning model into the predictive model.

4. The semiconductor process modeling method of claim 1,
wherein the process recipe includes a preventive maintenance (PM) period,
wherein the plurality of second tensor data include third tensor data indicating a time duration elapsed since a PM execution time point.

5. The semiconductor process modeling method of claim 4, wherein the inputting of the plurality of first tensor data and the plurality of second tensor data into the predictive model includes:
calculating each correlation coefficient between each of the plurality of first tensor data and the third tensor data;
selecting, from among the plurality of first tensor data, first tensor data for which a calculated correlation coefficient relative to the third tensor data exceeds a preset threshold; and
inputting the selected first tensor data and the third tensor data into the predictive model.

6. The semiconductor process modeling method of claim 5, wherein the inputting of the selected first tensor data and the third tensor data into the predictive model includes setting an initial value of the predictive model at each PM execution time point.

7. The semiconductor process modeling method of claim 1,
wherein the plurality of output data further include process result values on the second wafer,
wherein the method further comprises automatically updating the values of the process recipe based on the plurality of output data.

8. A semiconductor process modeling system comprising:
semiconductor process equipment configured to perform a semiconductor process according to a set process recipe to manufacture a resulting product;
a preprocessing processor configured to:
obtain, from the semiconductor process equipment, a plurality of first raw data including values of a process parameter on a plurality of first wafers and a plurality of second raw data including values of the process recipe on the plurality of first wafers; and
preprocess the plurality of first raw data and the plurality of second raw data to generate a plurality of first tensor data corresponding to the plurality of first raw data and a plurality of second tensor data corresponding to the plurality of second raw data; and
a modeling processor configured to input the plurality of first tensor data and the plurality of second tensor data into a predictive model and to output, from the predictive model, a plurality of output data including values of a process parameter on a second wafer.

9. The semiconductor process modeling system of claim 8, wherein the modeling processor is configured to:
calculate each correlation coefficient between each of the plurality of first tensor data and each of the plurality of second tensor data;
select, from among the plurality of first tensor data and the plurality of second tensor data, first tensor data and second tensor data between which a calculated correlation coefficient exceeds a preset threshold; and
input the selected first tensor data and the selected second tensor data into the predictive model and output, from the predictive model, the plurality of output data.

10. The semiconductor process modeling system of claim 8,
wherein the predictive model includes a Q-learning model,
wherein the modeling module is configured to input the plurality of first tensor data as a state of the Q-learning model into the predictive model, and input the plurality of second tensor data as an action of the Q-learning model into the predictive model.

11. The semiconductor process modeling system of claim 8,
wherein the process recipe includes a preventive maintenance (PM) period,
wherein the plurality of second tensor data include third tensor data indicating a time duration elapsed since a PM execution time point.

12. The semiconductor process modeling system of claim 11, wherein the modeling processor is configured to:
calculate each correlation coefficient between each of the plurality of first tensor data and the third tensor data;
select, from among the plurality of first tensor data, from among the plurality of first tensor data, first tensor data of which a calculated correlation coefficient relative to the third tensor data exceeds a preset threshold; and
input the selected first tensor data and the third tensor data into the predictive model.

13. The semiconductor process modeling system of claim 8, further comprising a recipe update processor configured to automatically update the values of the process recipe based on the plurality of output data,
wherein the plurality of output data further includes process result values on the second wafer.

14. A computer device comprising:
a processor; and
a memory connected to the memory and configured to store instructions,
wherein, when the instructions are executed by the processor, the instructions cause the processor to perform operations comprising:
obtaining a plurality of first raw data including values of a process parameter on a plurality of first wafers and a plurality of second raw data including values of a process recipe on the plurality of first wafers;
preprocessing the plurality of first raw data and the plurality of second raw data to generate a plurality of first tensor data corresponding to the plurality of first raw data and a plurality of second tensor data corresponding to the plurality of second raw data; and
inputting the plurality of first tensor data and the plurality of second tensor data into a predictive model; and
outputting, from the predictive model, a plurality of output data including values of a process parameter on a second wafer.

15. The computer device of claim 14, wherein the inputting the plurality of first tensor data and the plurality of second tensor data into the predictive model includes:
calculating each correlation coefficient between each of the plurality of first tensor data and each of the plurality of second tensor data;
selecting, from among the plurality of first tensor data and the plurality of second tensor data, first tensor data and second tensor data between which a calculated correlation coefficient exceeds a preset threshold; and
inputting the selected first tensor data and the selected second tensor data into the predictive model.

16. The computer device of claim 14,
wherein the predictive model includes a Q-learning model,
wherein the inputting the plurality of first tensor data and the plurality of second tensor data into the predictive model includes inputting the plurality of first tensor data as a state of the Q-learning model into the predictive model, and inputting the plurality of second tensor data as an action of the Q-learning model into the predictive model.

17. The computer device of claim 14,
wherein the process recipe includes a preventive maintenance (PM) period, and
wherein the plurality of second tensor data include third tensor data indicating a time duration elapsed since a PM execution time point.

18. The computer device of claim 17, wherein inputting the plurality of first tensor data and the plurality of second tensor data into the predictive model includes:
calculating each correlation coefficient between each of the plurality of first tensor data and the third tensor data;
selecting, from among the plurality of first tensor data, first tensor data of which a calculated correlation coefficient relative to the third tensor data exceeds a preset threshold; and
inputting the selected first tensor data and the third tensor data into the predictive model.

19. The computer device of claim 18, wherein inputting the selected first tensor data and the third tensor data into the predictive model includes setting an initial value of the predictive model at each PM execution time point.

20. The computer device of claim 14,
wherein the plurality of output data further include process result values on the second wafer,
wherein, when the instructions are executed by the processor, the instructions cause the processor to automatically update the values of the process recipe based on the plurality of output data.
